(19) United States
(12) Patent Application Publication
(10) Pub. No.: US 2011/0061662 A1
(43) Pub. Date: Mar. 17, 2011

(54) APPARATUS AND METHOD TO LIMIT EXPOSURE OF A BODY AREA TO RADIATION

(76) Inventor: Marvin Cohen, St. Louis, MO (US)

(21) Appl. No.: 12/559,092

(22) Filed: Sep. 14, 2009

(51) Int. Cl. A41D 13/11; G21F 1/00

(52) U.S. Cl. 128/857; 250/515.1

(57) ABSTRACT

An apparatus for limiting exposure of an underlying body area of a patient to radiation. The apparatus includes a mask defining a void. The mask is contoured to substantially conform to the underlying body area. A radiation barrier is positionable within the void to facilitate limiting exposure of at least a portion of the underlying body area to radiation.

### BACKGROUND OF THE INVENTION

The subject matter described herein relates generally to an apparatus and method for use in stabilizing a body part of a patient during a medical procedure, such as during radiation therapy and, more specifically, to an apparatus that includes one or more radiation barriers configured to protect at least a portion of an underlying body area from exposure to radiation.

Many medical procedures, including surgery and radiographic imaging, require stabilization and/or immobilization of specific body parts. Conventional apparatuses for use in stabilizing the body part during such procedures include padded supports or contoured mattresses. However, conventional apparatuses may not be suitable for stabilizing a patient's head during the procedure.

Radiographic images, such as a computed tomography (CT), a positron emission tomography (PET), or a magnetic resonance imaging (MRI) scan, of a body part are often necessary before performing surgery and are often used during surgery. During such procedures, a patient's head may be immobilized with an apparatus that includes invasive fixating pins. Although cranial fixation with invasive pins is adequate for some medical procedures, its use may be undesirable for other applications.

Further, underlying and/or adjacent structure or tissue, such as teeth, gingiva (gums), periodontal bone, the parotid and sublingual, salivary glands and/or related tissue, may be exposed to undesirable or excessive doses of radiation during such procedures. Exposure to radiation may result in harmful side effects.

### BRIEF DESCRIPTION OF THE INVENTION

In one aspect, an apparatus for limiting exposure of an underlying body area of a patient to radiation is provided. The apparatus includes a mask defining a void. The mask is contoured to substantially conform to the underlying body area. A radiation barrier is positionable within the void to facilitate limiting exposure of at least a portion of the underlying body area to radiation.

In another aspect, a mask configured to limit exposure of an underlying body area to radiation is provided. The mask includes a sheet of material defining at least one void. The sheet of material is moldable to conform to at least a portion of the underlying body area to be shielded. A radiation barrier is positionable within the at least one void to facilitate limiting exposure of at least a portion of the underlying body area to radiation.

In yet another aspect, a method is provided for treating a body area of a patient. The method includes molding a sheet of material to form a mask configured to conform to the body area. The sheet of material defines a void. A radiation barrier is positionable within the void to facilitate limiting exposure of at least a portion of the body area to radiation during treatment.

### BRIEF DESCRIPTION OF THE DRAWINGS

FIG. 1 shows a side view of an apparatus configured to limit exposure of an underlying body area to radiation with a patient's head oriented in a supine position;

FIG. 2 shows a front view of a radiation barrier suitable for use with the apparatus shown in FIG. 1;

FIG. 3 shows a top view of an exemplary support frame suitable for use with the apparatus shown in FIG. 1; and

FIG. 4 is a procedural flow diagram for an exemplary method for treating a body area of a patient.

### DETAILED DESCRIPTION OF THE INVENTION

The apparatus described herein includes a moldable mask having one or more radiation barriers that are configured to protect teeth, gingiva (gums), periodontal bone, the parotid and sublingual, salivary glands and/or related tissue against harmful side effects of radiation therapy. The radiation barrier may include one or more different radiation shielding materials that are known to protect against radiation, such as lead in sheet form or a composite material that includes a sheet or layer of lead positioned between layers of a suitable plastic material, for example. The radiation barrier may vary in thickness and other physical characteristics depending upon the intensity of radiation required for treatment and/or the patient being treated.

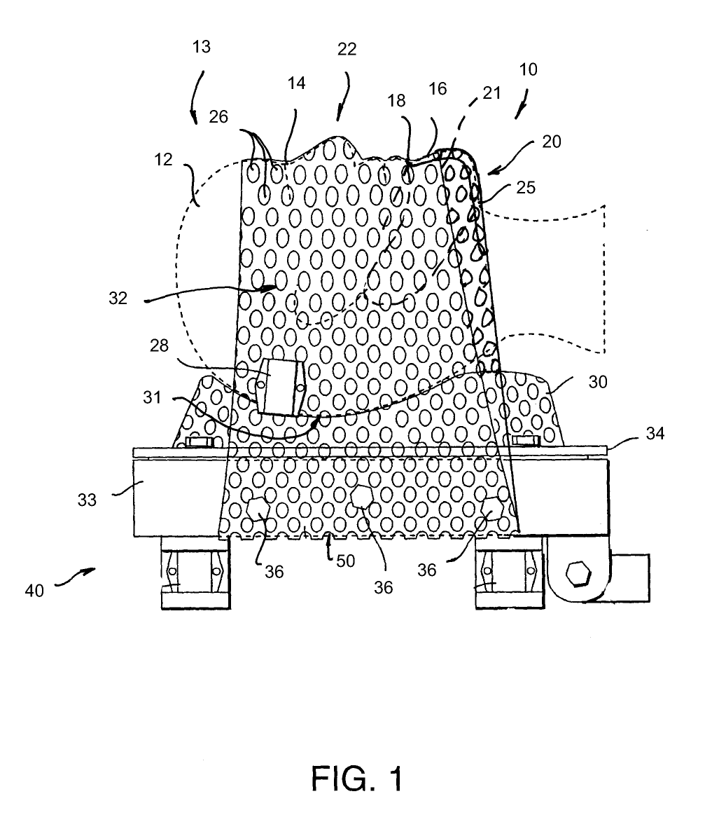

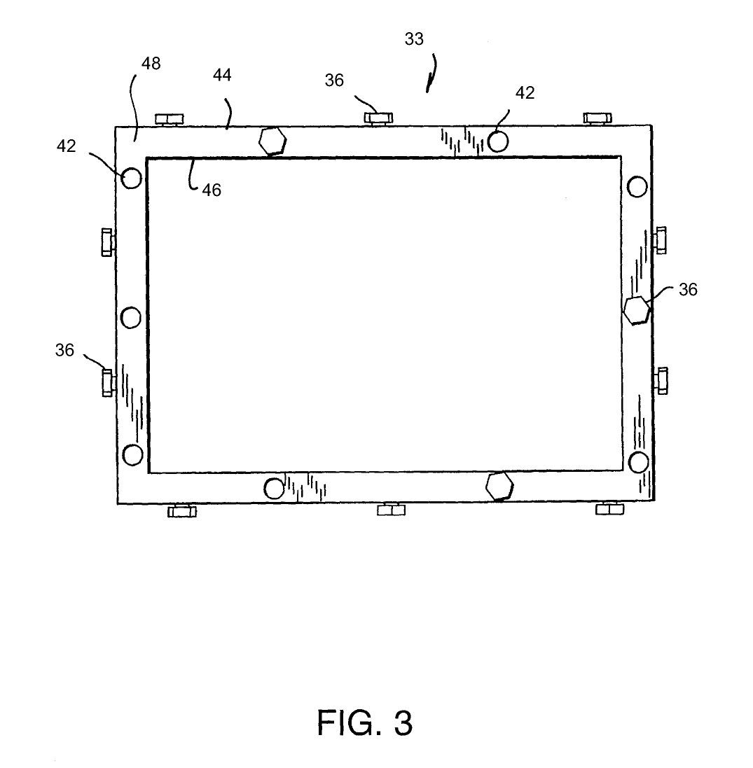

FIGS. 1-3 illustrate components of an apparatus 10 for use in stabilizing a body part. Apparatus 10 supports and/or immobilizes a head 12 of a patient 13 during a medical procedure, such as during radiation therapy. However, it should apparent to those skilled in the art that apparatus 10 may be suitably sized, shaped or oriented to support and/or immobilize other body parts, such as the patient's neck, back, pelvis, or at least a portion of an appendage, or may be positioned within a desired body area, such as on the patient's breast, chest, back, pelvis or abdomen during the medical procedure.

Referring further to FIG. 1, in the exemplary embodiment, apparatus 10 stabilizes head 12, shown by a dashed line, in a supine position. Apparatus 10 may also be configured to stabilize head 12 in a prone position and/or any suitable orientation, as desired.

In the exemplary embodiment, apparatus 10 includes a mask 14 that is formed from a suitable thermally-activated moldable sheet of material that is heated to a suitable softening temperature that is sufficiently low enough so that the patient can tolerate a direct molding process. The softened sheet is conformed to head 12 and allowed to cool. In this embodiment, mask 14 is formed as a direct molding of head 12 prior to the medical procedure. In the exemplary embodiment, the moldable material is a thin sheet of low temperature thermoplastic material commercially available under the name of Aquaplast™ from WFR/Aquaplast Corporation located in Avondale, Pa. 19311 (USA). In alternative embodiments, mask 14 may be formed from any suitable material or combination of materials including, without limitation, fiberglass, plaster, and/or foam. After proper molding and cooling, mask 14 conforms to a particular patient's head 12 to provide a personal fit for the support and immobilization of head 12 by apparatus 10. Mask 14 thus provides a hardened or rigid support structure that is contoured to correspond to the unique features of head 12 and to facilitate supporting and immobilizing head 12 during the medical procedure. As such, mask 14 is contoured to accommodate head 12.

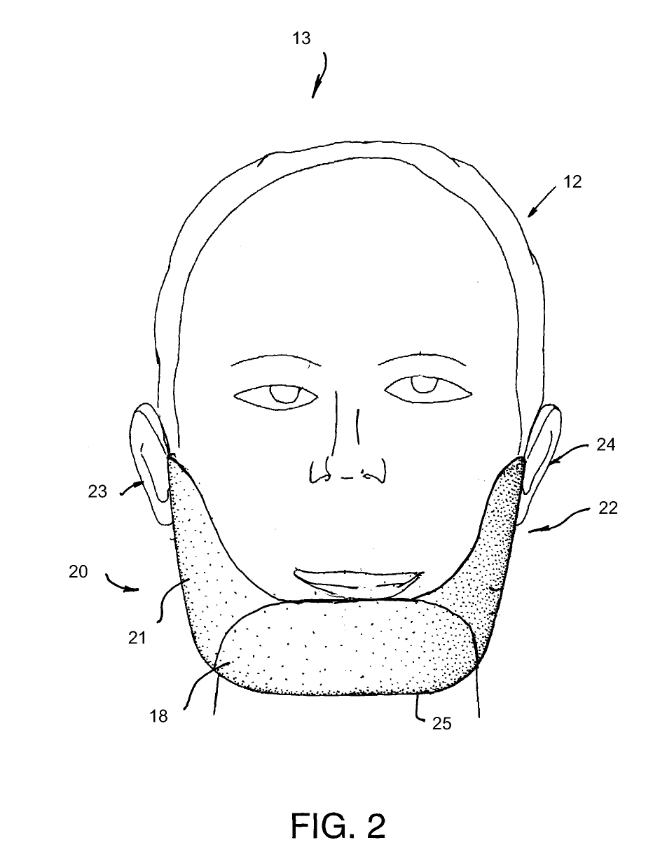

Referring further to FIGS. 1 and 2, in the exemplary embodiment, a radiation barrier 16 is positioned within a pocket or void 18 formed in mask 14. One or more voids 18 may be preformed on or formed within the sheet of material formed during the mask molding process. Radiation barrier 16 is positioned within a corresponding void 18 such that barrier 16 is positioned to facilitate shielding a selected area or portion of the patient's body, such as on or near the teeth, gingiva, periodontal bone, salivary glands and adjacent body areas. More specifically, barrier 16 is positioned to facilitate protecting desired areas of the patient's body from direct impingement of radiation used, for example, in radiation therapy, and applied to patient body areas such as the head, neck, and/or thyroid.

Radiation barrier 16 includes a radiation shielding material that is suitable for limiting or preventing undesirable radiation from contacting the selected body area and/or that facilitates preventing or limiting undesirable side effects including, without limitation, salivary gland atrophy and xerostomia (dry mouth), demineralization and break down of teeth enamel, stunted undeveloped roots, retarded eruption, and anodontia (missing teeth) in young patients, resorbtion of the alveolar bone and periodontitis (pyohorrea), infected teeth, and osteoradionecrosis. Suitable materials for radiation barrier 16 may include, without limitation, a lead-based material. In one embodiment, radiation barrier 16 is a composite material that includes an inner sheet or layer of lead material that is covered with a suitable material, such as a plastic material, that substantially prevents interaction and/or contact between the lead material and any surrounding tissue. In an alternative embodiment, a layer of fine lead particles is positioned between layers of a suitable material, such as a plastic material. Such suitable materials may include, without limitation, synthetic resins such as methyl methacrylates, synthetic polyamides such as nylon, and silicones for biological use commercially available from Dow Coming Corporation located in Midland, Mich. 48686 (USA). Moreover, radiation barrier 16 may be formed with any suitable shape, configuration, and/or orientation that facilitates radiation barrier 16 being positioned to substantially shield the selected body area from undesirable radiation exposure. In one embodiment, radiation barrier 16 has a thickness of about 1 millimeter (mm) to about 4 mm or, more specifically, about 2.75 mm to about 3.25 mm or, even more specifically, about 3 mm to about 3.10 mm.

As illustrated in FIGS. 1 and 2, radiation barrier 16 is generally arcuate in shape and is adapted to encompass a lower front portion 20 of head 12. In the exemplary embodiment, radiation barrier 16 includes rearwardly extended portions 21 that extend over and around a patient's face 22 substantially from ear 23 to ear 24, shown in FIG. 2, and a lower inwardly directed cap-shaped portion 25. The dimensions and configuration of radiation barrier 16 enable radiation barrier 16 to substantially cover the extraoral anatomy of the patient's face 22, and to substantially shield the parotid, sublingual and salivary glands from undesirable radiation exposure. During certain medical procedures it may not be desirable to include extended portions 21, such as when X-rays of the glands, for example, are to be taken.

In the exemplary embodiment, mask 14 includes a plurality of perforations 26 to facilitate patient comfort and to reduce erythema, as well as provide molding flexibility, if desired. Moreover, in the exemplary embodiment, mask 14 includes a plurality of fiducial markers 28 affixed to it.

Mask 14, in the exemplary embodiment, is formed around the patient's face 22 to enable subsequent medical procedures to be performed with the patient 13 in a prone position. Mask 14 also includes a cushion 30 that is molded against a back 31 or a side 32 of head 12 for use as a headrest or support. In the exemplary embodiment, cushion 30 is coupled to a support frame 33 with a suitable coupler, such as a clamp 34 and bolts 36. Alternatively, cushion 30 may be coupled directly to support frame 33 with bolts 36. Thus, when mask 14 is coupled to a medical procedure table (not shown) using a mounting assembly 40, head 12 is effectively stabilized without utilizing fixating pins or any other intrusive members.

In the exemplary embodiment, mask 14 is removably coupled to support frame 33. More specifically, in the exemplary embodiment, support frame 33 is substantially rectangular in shape and is sized to create a stable foundation to support head 12. Support frame 33 may be formed of any suitable material, including without limitation, a plastic or nylon material, such that unnecessary images or artifacts do not appear along with the image of the body part during the radiographic imaging.

Support frame 33, in the exemplary embodiment, includes a plurality of holes 42 for use in removably coupling mask 14 to support frame 33. Referring to FIGS. 1 and 2, in one embodiment, holes 42 are spaced about an outer perimeter 44, an inner perimeter 46, a top 48, and/or a bottom 50 opposing top 48 of support frame 33. The various locations of holes 42 enable masks 14 having different shapes and/or sizes with head 12 to be positioned or oriented as desired relative to support frame 33. In one embodiment, holes 42 are configured to receive nylon or plastic bolts 36. Mounting assembly 40 is also coupled to support frame 33 and is configured such that apparatus 10 may be coupled to a medical procedure table, a radiographic imaging table, or any suitable support structure.

Apparatus 10 may be utilized in a method for treating a body part or an area of a patient. Although the method is described herein in reference to a medical procedure related to head 12, it should be apparent to those skilled in the art that the apparatus and the method may be applied to other body parts or areas as well. Generally, the method involves the use of an apparatus as described above during a radiographic imaging process.

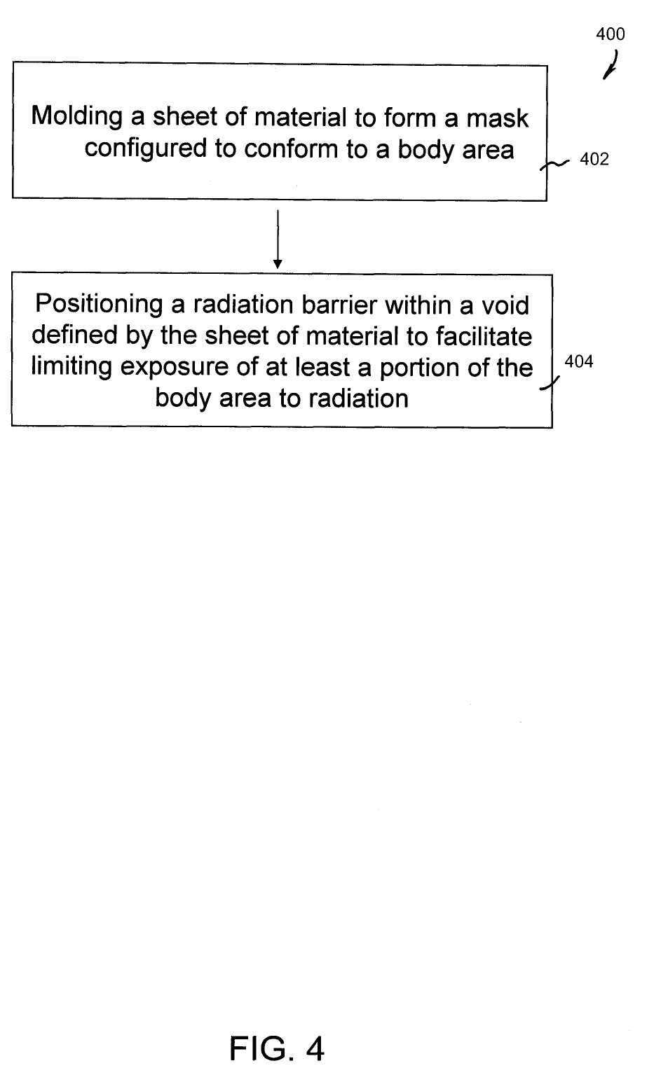

With reference to FIG. 4, a method for treating a body part or area of a patient is described. The patient is placed into a position that will enable a medical procedure to be performed. For example, the patient may be placed in a prone or supine position or other suitable orientation. A mask is formed 402 to conform to the patient's head or other body part or area for the procedure to be performed. In one embodiment, the mask is made of a thermally-activated moldable sheet of plastic material that is heated until the sheet of plastic material becomes moldable. The sheet of plastic material is then molded to follow the contours of the head and/or a face of the patient. The sheet of plastic material is cooled to form the rigid mask. In one embodiment, the sheet of plastic material is heated by submerging the sheet of plastic material into a hot water bath. The temperature of the water is high enough to soften the plastic material, and the precise temperature will depend upon the specific plastic material used. For example, when an Aquaplast™ material is utilized to form the mask, the water bath should be between 140° F. and 180° F. Due to the high temperatures involved, the molding process may be delayed until the temperature of the plastic material is tolerable to the patient.

During the molding process, facial protrusions, contours, and bony areas such as the nose, cheeks, forehead, and chin are accurately shaped. After molding the mask, the mask may remain on the patient until the mask has adequately cooled. When sufficiently cooled, the plastic material becomes rigid and the mask may be removed from the patient. A radiation barrier is positioned 404 within a void defined by the mask before or during the mask forming process. The radiation barrier is positioned to facilitate limiting exposure of at least a portion of the underlying body area to radiation during treatment.

With the mask positioned about the patient's head, the mask is coupled to the support frame, which is secured to a structure such as a bed or a table. In one embodiment, a cushion is positioned underneath the patient's head to provide added support and/or immobilization. After stabilizing the patient's head, a radiographic imaging procedure, such as a computed tomography (CT), positron emission tomography (PET), or magnetic resonance imaging (MRI) scan, may be performed.

One or more radiation barriers included in the mask are configured to protect teeth, gingiva (gums), periodontal bone, the parotid and sublingual, salivary glands and/or related tissue against harmful side effects of radiation emitted during the imaging procedure. The radiation barrier may include one or more different radiation shielding materials that are known to protect against radiation, such as lead in sheet form or a composite material that includes a sheet or layer of lead positioned between layers of a suitable plastic material, for example. The radiation barrier may vary in thickness and other physical characteristics depending upon the intensity of radiation required for treatment, the treatment area, and/or the patient being treated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for limiting exposure of an underlying body area of a patient to radiation, said apparatus comprising:
a mask defining a void, said mask contoured to substantially conform to the underlying body area; and
a radiation barrier positionable within the void to facilitate limiting exposure of at least a portion of the underlying body area to radiation.

2. An apparatus in accordance with claim 1 further comprising a support frame, said mask removably coupled to said support frame to facilitate immobilizing the underlying body area.

3. An apparatus in accordance with claim 1 further comprising a cushion configured to facilitate supporting the underlying body area.

4. An apparatus in accordance with claim 1 wherein said mask comprises a thermally-activated moldable sheet of material.

5. An apparatus in accordance with claim 1 wherein said radiation barrier comprises a radiation-shielding material.

6. An apparatus in accordance with claim 5 wherein said radiation barrier comprises a composite material comprising an inner sheet of lead material covered with a plastic material.

7. An apparatus in accordance with claim 1 wherein said radiation barrier has a thickness of between about 1 millimeter to about 5 millimeters.

8. An apparatus in accordance with claim 1 wherein said void is preformed within said mask.

9. An apparatus in accordance with claim 1 wherein said void is formed during a mask molding process.

10. An apparatus in accordance with claim 1 wherein said mask defines a plurality of voids, each of said plurality of voids is configured to receive a radiation barrier therein.

11. A mask configured to limit exposure of an underlying body area to radiation, said mask comprising:
a sheet of material defining at least one void, said sheet of material moldable to conform to at least a portion of the underlying body area to be shielded; and
a radiation barrier positionable within the at least one void to facilitate limiting exposure of at least a portion of the underlying body area to radiation.

12. A mask in accordance with claim 11 wherein said sheet of material comprises a thermally-activated moldable sheet of material.

13. A mask in accordance with claim 11 wherein said radiation barrier comprises a radiation shielding material.

14. A mask in accordance with claim 13 wherein said radiation barrier comprises a composite material comprising an inner sheet of lead material positioned adjacent to a plastic material.

15. A mask in accordance with claim 11 wherein said radiation barrier has a thickness of between about 1 millimeter to about 5 millimeters.

16. A mask in accordance with claim 11 wherein said void is one of preformed and formed during a mask molding process.

17. A mask in accordance with claim 11 wherein said mask defines a plurality of voids, each of said plurality of voids is configured to receive a radiation barrier therein.

18. A mask in accordance with claim 11 wherein said radiation barrier substantially covers at least one of a patient's teeth, gingiva, periodontal bone, extraoral area of a face, the parotid and sublingual, and salivary glands.

19. A mask in accordance with claim 11 wherein said radiation barrier comprises at least one rearwardly extending portion configured to extend over a portion of a face of the patient.

20. A method for treating a body area of a patient, said method comprising:
molding a sheet of material to form a mask configured to conform to the body area, the sheet of material defining a void; and
positioning a radiation barrier within the void to facilitate limiting exposure of at least a portion of the body area to radiation during treatment.
